(19) United States
(12) Patent Application Publication
(10) Pub. No.: US 2025/0217123 A1
(43) Pub. Date: Jul. 3, 2025

(54) CHECKING CODE COMPLETENESS WITH HAPAX LEGOMENON

(71) Applicant: INTERNATIONAL BUSINESS MACHINES CORPORATION, ARMONK, NY (US)

(72) Inventors: ANDREW C. M. HICKS, HIGHLAND, NY (US); MICHAEL GAGLIARDI, SOMERSET, MA (US); RYAN LO, POUGHKEEPSIE, NY (US)

(21) Appl. No.: 18/397,576

(22) Filed: Dec. 27, 2023

(51) Int. Cl. G06F 8/41; G06F 8/35

(52) U.S. Cl. CPC G06F 8/433; G06F 8/35; G06F 8/4435

(57) ABSTRACT

Checking code completeness with hapax legomenon, including: receiving code generated by a generative artificial intelligence (AI) model; determining whether the code includes one or more single-use programming constructs; and flagging the code in response to the code including the one or more single-use programming constructs.

### BACKGROUND

The present disclosure relates to methods, apparatus, and products for checking code completeness with hapax legomenon. Generative artificial intelligence (AI) may be used to generate code, such as application source code. Such code may be based on a prompt provided to a generative AI model describing the functionality that the code should perform. Such code may also include conversions performed by the generative AI model from one programming language to another. When generating code, the generative AI model may introduce single-use programming constructs into the code, which are programming constructs such as functions or variables that are defined but never used. Though the code may compile and execute correctly, the presence of these single-use programming constructs may affect performance and memory usage.

### SUMMARY

According to embodiments of the present disclosure, various methods, apparatus and products for checking code completeness with hapax legomenon are described herein. In some aspects, checking code completeness with hapax legomenon includes receiving code generated by a generative artificial intelligence (AI) model; determining whether the code includes one or more single-use programming constructs; and flagging the code in response to the code including the one or more single-use programming constructs. This provides the advantage of identifying single-use programming constructs in AI-generated code, the importance of whose presence is first recognized by this disclosure. This may allow for the removal of identified single-use programming constructs so as to improve the performance of AI-generated code and may allow for refinement of the generative AI model for future code generation. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

In some aspects, determining whether the code includes the one or more single-use programming constructs may include identifying any single-use programming constructs in the code. This provides the advantage of identifying and flagging any single-use programming construct in the AI-generated code, regardless of whether these single-use programming constructs were introduced by the generative AI model or present in some base code. In some aspects, determining whether the code includes the one or more single-use programming constructs includes identifying, in the converted code, a single-use programming construct not having a corresponding single-use programming construct in the base code. This provides the advantage of identifying and flagging only those single-use programming constructs introduced by the generative AI model, omitting those that were originally present in the base code.

### BRIEF DESCRIPTION OF THE DRAWINGS

FIG. 1 sets forth an example computing environment for checking code completeness with hapax legomenon in accordance with some embodiments of the present disclosure.

FIG. 2 sets forth a flowchart of an example method of checking code completeness with hapax legomenon in accordance with some embodiments of the present disclosure.

FIG. 3 sets forth a flowchart of another example method of checking code completeness with hapax legomenon in accordance with some embodiments of the present disclosure.

FIG. 4 sets forth a flowchart of another example method of checking code completeness with hapax legomenon in accordance with some embodiments of the present disclosure.

### DETAILED DESCRIPTION

Generative artificial intelligence (AI) uses models such as neural networks to generate content, such as text, code, graphics, animations, video, audiovisual representations, audio, speech, etc., in response to prompts. Such prompts may include natural language inputs describing the content that the generative AI model is to generate. Such prompts may also include other data that may be used by the generative AI model in generating the requested content. For example, generative AI models may be used to generate code, such as source code, based on a description of the functionality that the generated code is to implement. As another example, generative AI models may be used to convert code from one programming language to another by providing the base code as input to the generative AI model.

Depending on the particular model used and how that model was trained, code generated by a generative AI model may include certain defects, anomalies, or other undesirable characteristics. Particularly, some AI-generated code may include a “hapax legomenon,” which is a word or expression that occurs within some context. In the context of source code, a hapax legomenon may include a single-use programming construct. A programming construct may include, for example, a function or a variable that may be defined within the code. Such programming constructs may be considered “single-use” in that they are defined but not used. For example, single-use variable may include a variable that is defined or instantiated but never used in any particular function or operation. As another example, a single-use function may include a function that is defined but never called by any other portion of code, and therefore will never be executed.

Existing benchmarking or testing approaches for AI-generated code may not be affected by the inclusion of single-use programming constructs. For example, the AI-generated code may compile and execute correctly despite the inclusion of single-use programming constructs. However, their inclusion may nonetheless affect the performance and memory usage of a program that uses the AI-generated code. Accordingly, it may be beneficial to identify where single-use programming constructs are present in AI-generated code.

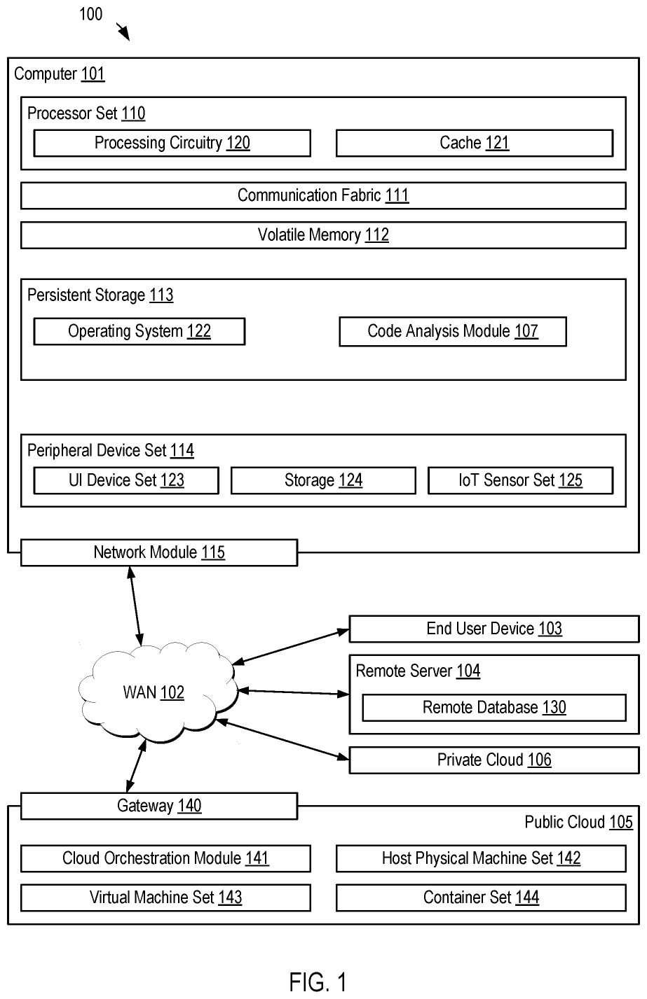

With reference now to FIG. 1, shown is an example computing environment according to aspects of the present disclosure. Computing environment 100 contains an example of an environment for the execution of at least some of the computer code involved in performing the various methods described herein, such as the code analysis module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

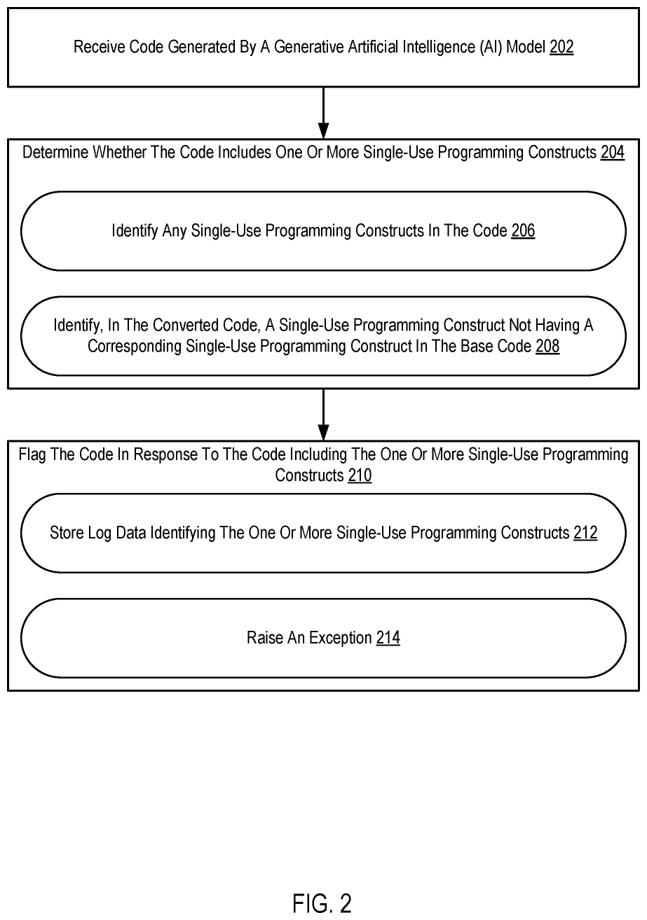

For further explanation, FIG. 2 sets forth a flowchart of an example method of checking code completeness with hapax legomenon in accordance with some embodiments of the present disclosure. The method of FIG. 2 may be performed, for example, by the code analysis module 107 of FIG. 1. As an example, in some embodiments, the method of FIG. 2 may be performed in response to a request to compile some AI-generated code or during the compilation of such code. As another example, in some embodiments, the method of FIG. 2 may be performed in response to receiving some code from a generative AI model based on some request or prompt.

The method of FIG. 2 includes receiving 202 code generated by a generative AI model. In some embodiments, receiving 202 code generated by a generative AI model includes receiving the code as output by the generative AI model. For example, the generative AI model may be configured to output code and provide that code to a process or service performing the method of FIG. 2. In some embodiments, receiving 202 code generated by the generative AI model includes loading the code from storage in which the code was stored after being generated by the generative AI model.

In some embodiments, the code generated by the generative AI model includes code generated based on a prompt including a natural language description of some functionality that the code should implement or perform. For example, a prompt to the generative AI model may request code that performs a particular task (e.g., opens a network connection to a particular destination, instantiates a database table having particular features, or any other task as can be appreciated).

In some embodiments, the code generated by the generative AI model includes code in some programming language converted from other code in a different programming language. For example, the generative AI model may be provided with some Cobol code and may be prompted to convert that Cobol code into Java. In examples related to the conversion of code using a generative AI model described below, the code input to the generative AI model is hereinafter referred to as “base code” while the code output by the generative AI model is hereinafter referred to as “converted code.”

The method of FIG. 2 also includes determining 204 whether the code includes one or more single-use programming constructs. As is set forth above, a single-use programming construct is a programming construct, such as a variable or function, that is defined in the code but not used. For example, a single-use programming construct may include a variable that is defined but not otherwise used or accessed in the code. As another example, a single-use programming construct may include a function that is defined but not called in another portion of the code, and therefore will never be executed.

In some embodiments, determining 204 whether the code includes one or more single-use programming constructs may include identifying 206 any single-use programming constructs in the code. Thus, any single-use programming construct present in the code may be included in the one or more single-use programming constructs. Embodiments where determining 204 whether the code includes one or more single-use programming constructs includes identifying 206 any single-use programming constructs in the code provides the advantage of identifying any or all single-use programming constructs in the code, regardless of whether they were present in some base code from which the AI-generated code was derived. This may allow for these originally-present single-use programming constructs to be removed so as to further optimize the AI-generated code relative to the base code. In some embodiments, the code may be parsed to generate a table or other data structure of programming constructs. Programming constructs may be added to such a table or data structure in response to detecting their definition in the code and/or their use in the code.

Accordingly, in some embodiments, identifying 206 any single-use programming constructs in the code may include accessing a table or data structure of programming constructs and determining whether an entry indicates that the programming construct has not been used. In some embodiments, such a table or data structure may maintain a number of times that a given programming construct is used in the code. In some embodiments, such a table or data structure may maintain a binary indication of whether or not a given programming construct is used in the code. In some embodiments, such a table structure may be generated during compilation of the code. For example, such a table or data structure may be embodied as an extension of a symbol table generated during compilation of the code. In some embodiments, such a table structure may be generated independent of any compilation of the code. One skilled in the art will appreciate that other approaches not using such a table or data structure may also be used in identifying single-use programming constructs.

In embodiments where the code includes converted code generated from some base code, the base code may itself include single-use programming constructs. The converted code may also include single-use programming constructs by virtue of their inclusion in the base code. The presence of single-use programming constructs in the converted code may not be indicative of any fault or programmatic error in the generative AI model. Thus, identifying 206 any single-use programming constructs in the code may cause single-use programming constructs to be incorrectly identified or treated as erroneous.

Accordingly, in some embodiments where the code is converted code, determining 204 whether the code includes one or more single-use programming constructs may include identifying 208, in the converted code, a single-use programming construct not having a corresponding single-use programming construct in the base code. Thus, it may be determined 204 that the code includes one or more single-use programming constructs (e.g., for the purpose of flagging described below) where such single-use programming constructs in the converted code are not reflected in the base code. Embodiments where determining 204 whether the code includes one or more single-use programming constructs includes identifying 208, in the converted code, a single-use programming construct not having a corresponding single-use programming construct in the base code allows for the identification of only those single-use programming constructs introduced by the generative AI model, ignoring those that were originally present in the base code. This may be used to identify and remediate defects or faults in the generative AI model.

For example, in some embodiments, the generative AI model may be trained or configured to use identical function names and/or variable names across base code and converted code. Accordingly, in some embodiments, both the base code and the converted code may be parsed as described above in order to identify their programming constructs and whether those programming constructs are used in their respective code. Using shared names or other identifiers, identifying 208, in the converted code, a single-use programming construct not having a corresponding single-use programming construct in the base code may include identifying a single-use programming construct in the table or data structure for the converted code that does not have a corresponding (e.g., having a matching identifier) entry in the table or data structure for the base code.

In some embodiments, determining 204 whether the code includes one or more single-use programming constructs may include either identifying 206 any single-use programming constructs in the code or identifying 208, in the converted code, a single-use programming construct not having a corresponding single-use programming construct in the base code (e.g., exclusive of one another). In some embodiments, determining 204 whether the code includes one or more single-use programming constructs may include both identifying 206 any single-use programming constructs in the code and identifying 208, in the converted code, a single-use programming construct not having a corresponding single-use programming construct in the base code. For example, determining 204 whether the code includes one or more single-use programming constructs may include identifying 206 any single-use programming constructs in the code. A single-use programming construct not having a corresponding single-use programming construct in the base code may then be identified 208 from those identified 206 single-use programming constructs. As will be described in further detail below, the code and/or the single-use programming constructs may be flagged differently depending on whether they were included in the original base code.

The method of FIG. 2 also includes flagging 210 the code in response to the code including the one or more single-use programming constructs. Flagging 210 the code may include a variety of actions that indicate that the code included the one or more single-use programming constructs. For example, in some embodiments, flagging 210 the code may include storing log data identifying the one or more single-use programming constructs. Such log data may include metadata of the code or other data as can be appreciated. In some embodiments, such log data may indicate where in the code a particular single-use programming construct is present. In some embodiments, such log data may indicate a type of single-use programming construct that was identified (e.g., variable or function). In some embodiments, where the code includes converted code, such log data may indicate whether a corresponding single-use programming construct was present in the base code and, if so, where it is located.

In some embodiments, flagging 210 the code may include raising 214 an exception. Raising 214 an exception may cause an operation applied to the code to stop or otherwise handle the exception, such as a code compilation operation or code execution operation. In some embodiments, the exception may include or be encoded with attributes similar to those as described above with respect to log data, including where the single-use programming construct is identified, a type of single-use programming construct that was identified, and the like. In some embodiments where the code includes converted code, raising 214 the exception may be based on whether the single-use programming construct was present in the base code, thereby allowing for different types of exceptions to be handled differently. For example, a warning may be raised where the single-use programming construct was present in the base code while an error may be raised where the single-use programming construct was not present in the base code.

Other actions may also be taken in response to flagging 210 the code. For example, in some embodiments, the identified single-use programming constructs may be automatically removed from the code. As another example, in some embodiments, the generative AI model may be provided, as feedback, an indication that the generated code included the one or more single-use programming constructs.

In some embodiments, the code may be flagged 210 based on criteria beyond the inclusion of single-use programming constructs in the code. For example, in some embodiments, the code may be flagged 210 according to similar approaches as are set forth above where a programming construct is included in the converted code an unequal number of times compared to the base code. This would include circumstances as described above where a single-use programming construct is included in the converted code but not the base code. This would also include circumstances where a programming construct may be used once or twice (e.g., some amount, some amount below a threshold) in the converted code and used an unequal amount, or not at all, in the base code.

The approaches set forth herein allow for the identification of single-use programming constructs in AI-generated code. This may allow for the removal of single-use programming constructs that may affect performance or memory usage of programs. This may also provide a feedback mechanism for the generative AI model to improve its code generation to prevent the inclusion of single-use programming constructs.

Although the approaches set forth above are described with respect to code received from a generative AI model, the approaches set forth herein may also be performed by the generative AI model as part of the code generation process. For example, after generating some code, the generative AI model may identify and potentially remove single-use programming constructs prior to outputting the code. Moreover, the approaches set forth herein may also be applied to code that was not generated by a generative AI model.

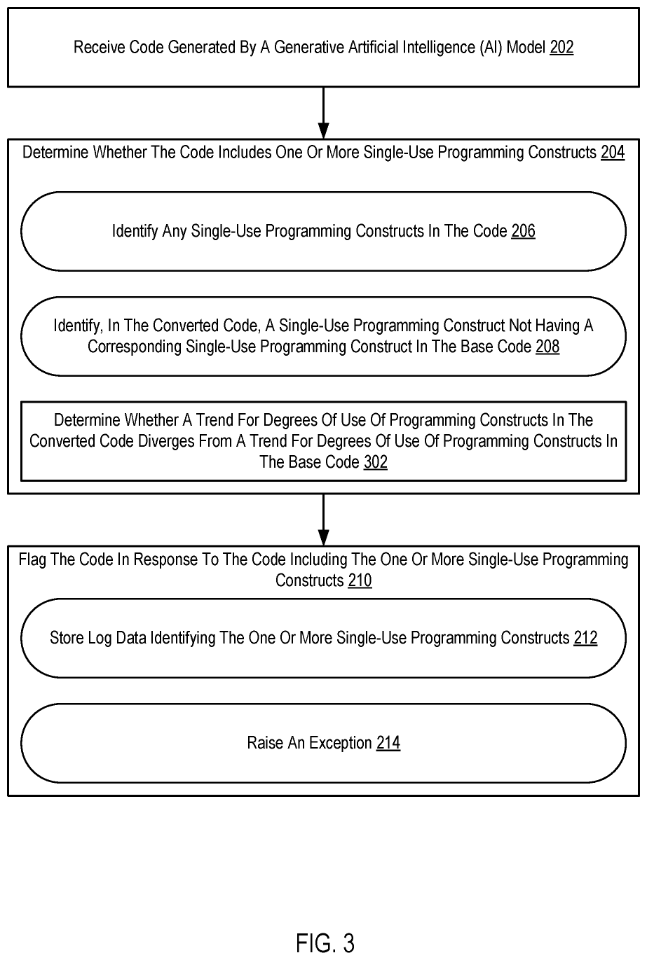

For further explanation, FIG. 3 sets forth a flowchart of another example method of checking code completeness with hapax legomenon in accordance with some embodiments of the present disclosure. The method of FIG. 3 is similar to FIG. 2 in that the method of FIG. 3 also includes: receiving 202 code generated by a generative artificial intelligence (AI) model; determining 204 whether the code includes one or more single-use programming constructs, including: identifying 206 any single-use programming constructs in the code; or identifying 208, in the converted code, a single-use programming construct not having a corresponding single-use programming construct in the base code; and flagging 210 the code in response to the code including the one or more single-use programming constructs, including: storing 212 log data identifying the one or more single-use programming constructs; or raising 214 an exception.

The method of FIG. 3 differs from FIG. 2 in that determining 204 whether the code includes one or more single-use programming constructs includes determining 302 whether a trend for degrees of use of programming constructs in the converted code diverges from a trend for degrees of use of programming constructs in the base code. In some embodiments, degrees of use for programming constructs in code can be tracked and counted by parsing that code. For example, for each identified programming construct in some code, a number of times that programming construct is used may be counted (e.g., each time a function is called, each time a variable is used, and the like). Using these counts, a trend for the degrees of use of programming constructs may be calculated for some code. As an example, the trend may describe or plot how many programming constructs are used a given number of times (e.g., N programming constructs are used five times, M programming constructs are used four times). The trend for the base code may be compared to the trend for the converted code as this plot approaches the number of programming constructs that are used zero times (e.g., a number of single-use programming constructs). A divergence between these trends (e.g., a difference in the rate of change in trends exceeding some threshold) may indicate that the converted code includes a significant number of single-use programming constructs compared to the base code. Accordingly, this may cause a determination 204 that the code includes one or more single-use programming constructs, triggering the flagging 210 as described above. In some embodiments, this may cause the code as a whole to be flagged 210 (e.g., without identifying particular single-use programming constructs) or may cause particular single-use programming constructs to be identified when the code is flagged 210.

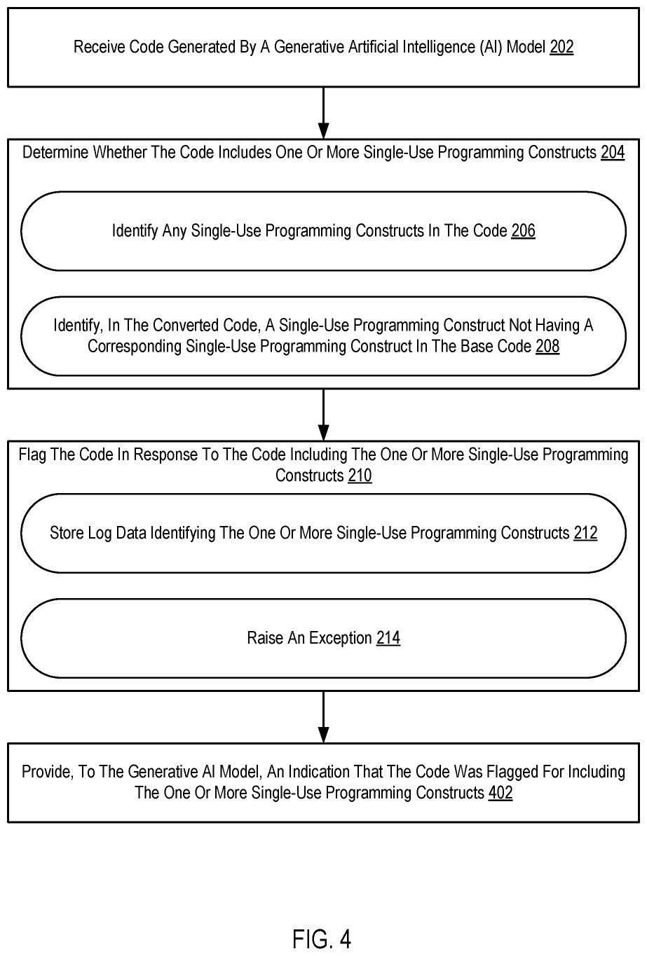

For further explanation, FIG. 4 sets forth a flowchart of another example method of checking code completeness with hapax legomenon in accordance with some embodiments of the present disclosure. The method of FIG. 4 is similar to FIG. 2 in that the method of FIG. 4 also includes: receiving 202 code generated by a generative artificial intelligence (AI) model; determining 204 whether the code includes one or more single-use programming constructs, including: identifying 206 any single-use programming constructs in the code; or identifying 208, in the converted code, a single-use programming construct not having a corresponding single-use programming construct in the base code; and flagging 210 the code in response to the code including the one or more single-use programming constructs, including: storing 212 log data identifying the one or more single-use programming constructs; or raising 214 an exception.

The method of FIG. 4 differs from FIG. 2 in that the method of FIG. 4 also includes providing 402, to the generative AI model, an indication that the code was flagged for including the one or more single-use programming constructs. Put differently, an indication is provided to the generative AI model that the code generated by the generative AI model included single-use programming constructs. In some embodiments, the indication to the generative AI model may include the stored 212 log data and/or the raised 214 exception described above. In some embodiments, the indication to the generative AI model may include any of the information described as potentially being included in the log data or exception as described above. For example, the indication may identify, in the code, the particular single-use programming constructs, a type of single-use programming construct, whether that single-use programming construct was present in the base code input to the generative AI model, and the like. The indication may also include other information as can be appreciated.

The generative AI model may use the indication in a variety of ways. For example, in some embodiments, the indication may be provided as part of a prompt to the generative AI model to regenerate the code without single-use programming constructs. As another example, in some embodiments, the indication may be provided as a portion of training data for retraining the generative AI model. This may cause the generative AI model to produce fewer single-use programming constructs in code after retraining.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
receiving code generated by a generative artificial intelligence (AI) model;
determining whether the code includes one or more single-use programming constructs; and
flagging the code in response to the code including the one or more single-use programming constructs.

2. The method of claim 1, wherein determining whether the code includes the one or more single-use programming constructs comprises identifying any single-use programming constructs in the code.

3. The method of claim 1, wherein the code generated by the generative AI model comprises converted code in a first programming language converted by the generative AI model from base code in a second programming language.

4. The method of claim 3, wherein determining whether the code includes the one or more single-use programming constructs comprises identifying, in the converted code, a single-use programming construct not having a corresponding single-use programming construct in the base code.

5. The method of claim 3, wherein determining whether the code includes the one or more single-use programming constructs comprises determining whether a trend for degrees of occurrence of programming constructs in the converted code diverges from a trend for degrees of occurrence of programming constructs in the base code.

6. The method of claim 1, wherein the one or more single-use programming constructs comprise an unused defined variable.

7. The method of claim 1, wherein the one or more single-use programming constructs comprise an uncalled defined function.

8. The method of claim 1, further comprising providing, to the generative AI model, an indication that the code was flagged for including the one or more single-use programming constructs.

9. The method of claim 1, wherein flagging the code in response to the code including the one or more single-use programming constructs comprises storing log data identifying the one or more single-use programming constructs.

10. The method of claim 1, wherein flagging the code in response to the code including the one or more single-use programming constructs comprises raising an exception.

11. An apparatus comprising:
a processing device; and
memory operatively coupled to the processing device, wherein the memory stores computer program instructions that, when executed, cause the processing device to:
receive code generated by a generative artificial intelligence (AI) model;
determine whether the code includes one or more single-use programming constructs; and
flag the code in response to the code including the one or more single-use programming constructs.

12. The apparatus of claim 11, wherein determining whether the code includes the one or more single-use programming constructs comprises identifying any single-use programming constructs in the code.

13. The apparatus of claim 11, wherein the code generated by the generative AI model comprises converted code in a first programming language converted by the generative AI model from base code in a second programming language.

14. The apparatus of claim 13, wherein determining whether the code includes the one or more single-use programming constructs comprises identifying, in the converted code, a single-use programming construct not having a corresponding single-use programming construct in the base code.

15. The apparatus of claim 13, wherein determining whether the code includes the one or more single-use programming constructs comprises determining whether a trend for degrees of occurrence of programming constructs in the converted code diverges from a trend for degrees of occurrence of programming constructs in the base code.

16. The apparatus of claim 11, wherein the one or more single-use programming constructs comprise an unused defined variable.

17. The apparatus of claim 11, wherein the one or more single-use programming constructs comprise an uncalled defined function.

18. The apparatus of claim 11, computer program instructions that, when executed, cause the processing device to provide, to the generative AI model, an indication that the code was flagged for including the one or more single-use programming constructs.

19. The apparatus of claim 11, wherein flagging the code in response to the code including the one or more single-use programming constructs comprises storing log data identifying the one or more single-use programming constructs.

20. The apparatus of claim 11, wherein flagging the code in response to the code including the one or more single-use programming constructs comprises raising an exception.

21. A computer program product comprising a computer readable storage medium, wherein the computer readable storage medium comprises computer program instructions that, when executed:
receive code generated by a generative artificial intelligence (AI) model;
determine whether the code includes one or more single-use programming constructs; and
flag the code in response to the code including the one or more single-use programming constructs.

22. The computer program product of claim 21, wherein determining whether the code includes the one or more single-use programming constructs comprises identifying any single-use programming constructs in the code.

23. The computer program product of claim 21, wherein the code generated by the generative AI model comprises converted code in a first programming language converted by the generative AI model from base code in a second programming language.

24. The computer program product of claim 23, wherein determining whether the code includes the one or more single-use programming constructs comprises identifying, in the converted code, a single-use programming construct not having a corresponding single-use programming construct in the base code.

25. The computer program product of claim 23, wherein determining whether the code includes the one or more single-use programming constructs comprises determining whether a trend for degrees of occurrence of programming constructs in the converted code diverges from a trend for degrees of occurrence of programming constructs in the base code.
